(19) United States
(12) Patent Application Publication
(10) Pub. No.: US 2014/0127657 A1
(43) Pub. Date: May 8, 2014

(54) TOILET TRAINING DEVICE

(71) Applicant: Michael Traxler, Simi Valley, CA (US)

(72) Inventor: Michael Traxler, Simi Valley, CA (US)

(21) Appl. No.: 13/670,414

(22) Filed: Nov. 6, 2012

(51) Int. Cl. G09B 19/00

(52) U.S. Cl. 434/247

(57) ABSTRACT

The invention is a toilet training device for boys. Specifically, the invention is a target that is attached to the rim of a toilet bowl and shifts into place when the toilet set is lifted, and shifts or swings out of the way when the toilet seat is put down.

### FIELD OF THE INVENTION

This device generally relates to toilet training devices for boys. More particularly, the invention is a target that is designed to be aimed at by a boy who is being potty trained. The target is preferably attached to the rim of a toilet bowl and preferably shifts into place when the toilet seat is lifted and shifts out of the way when the toilet seat is lowered.

### BACKGROUND OF INVENTION

Potty training is an inevitable part of every child's life. Studies have shown that young boys are more difficult to potty train than young girls. Girls may be easier to potty train because moms typically act as the primary potty trainers within a family. Because mothers usually potty train children, young girls have the advantage of observing someone with the same organs. Boys, on the other hand, especially those that do not also have a father helping out with the potty training, do not have the advantage of observational learning. This may contribute to the greater difficulty associated with toilet training boys. Another possible explanation for boys having more difficulty than girls to potty train is that boys are more active than girls and therefore less likely to stop and take the time to use the potty properly, Still another theory postulates that boys take longer than girls to train because potty training boys involves a two-step process: (1) teaching the boy to use the toilet while sitting down and (2) teaching the boy to urinate standing up. Girls, on the other hand, only need to be taught to use the potty sitting down.

Because bowel movements and urine frequently come out at the same time. children, both boys and girls, are usually initially taught to use the toilet while sitting down, This helps to teach them that both feces and urine belong in the toilet. Additionally, it eliminates the distraction that the additional task of aiming and releasing urine into a toilet may create.

Once a boy has mastered using the toilet sitting down, the boy is ready to advance to learning to urinate standing up. Most boys do not learn how to do this right away, and they may not learn how to do this for some time after they have learned to use a toilet while sitting down. One of the keys to teach a young boy how to urinate While standing up is to have a readily available male observational model. The boy typically follows his Dad and watches him urinate while standing up. Once the boy understands the concept of standing and urinating in the toilet, he next has to learn how to effectively stand and aim his urine into the center of the toilet. While some methods, such as tossing some Cheerios or floating a paper target into the water bowl of the toilet to act as targets, currently exist for helping teach young boy to aim their urine, these methods are not very effective or interactive. What is needed is a toilet training aid for boys that acts as an interactive target and effectively teaches boys to aim for the center of the toilet when peeing while standing up.

Several references disclose various devices for teaching boys to pee standing up. One such reference is U.S. Pat. No. 7,017,198, issued to Donna Fair Conn and William Edward Conn, which discloses “a flexible protector urine shield mounted with front and back support rods, wherein the front rod allows for targets to be placed in the center of the toilet to train boys to aim more efficiently,” The Conn invention has several drawbacks, including the fact that it must be physically removed from the toilet in order to put the seat down, and therefore cannot constantly remain on the toilet. Additionally, the Conn invention does not incorporate any sports themed target that transform the act of urinating into a toilet to a fun game.

Another potty training device is disclosed by U.S. Published Patent Application Number 2011/0318720, filed by Giard. Giard discloses a potty training device with a target attached to a bent rod that is clamped to the side of a toilet howl, When a toilet seat is lowered onto Giard's device, a button is depressed which pivots the rod with the aiming target towards the side of the toilet bowl. When a toilet seat is raised, the button on Giard's device is released and the rod with the aiming target pivots to the center of the toilet. Giard's device differs from present invention in two critical ways. First, Giard's device uses a button activated, rotating device mechanism to move the target from the center of the toilet to the side of the toilet, depending on the position of the toilet seat. Applicant's device, on the other hand, uses only a simple lever mechanism. Secondly, Giard's device does not include a sports themed target, whereas Applicant's device preferably includes the sports themed target of a basketball hoop.

Importantly, none of the currently available toilet training devices or references discloses the use of levers to move a target from the center of a toilet bowl when a toilet seat is up and back of the toilet when the toilet seat is down.

### SUMMARY OF THE INVENTION

The embodiments of this device are directed towards overcoming the above deficiencies of the prior art by providing an easy-to-use toilet training target that can be left on the toilet at all times, is located at the back of a toilet bowl when a toilet seat is down, shifts to the center of the bowl when the toilet seat is up, and preferably incorporates the theme of a sports game.

One embodiment of the invention is a toilet training device, comprising: one or more targets; a strap; and one or more levers. The targets are attached to the strap. The toilet training device is attached to a rim of a toilet bowl. The levers are attached to the strap such that the levers counter balance the strap such that when the toilet seat is down the levers cause the strap to be positioned along the rim of the toilet bowl and when the toilet seat is up the strap shifts such that the one or more targets are positioned substantially in a center of the toilet bowl. Preferably, the device includes two or more toilet bowl attachment portions, which are attached to the strap and secure the device to the rim of the toilet bowl. Preferably, the two or more toilet bowl attachment portions are comprised of a lever hinge. Preferably, the lever hinge allows the strap to shift from being positioned along the rim of the toilet bowl to being positioned substantially in a center of the toilet bowl. Preferably, the one or more targets are one or more sports goals, such as basketball hoops or basketball hoops with backboards. Preferably, the one or more targets are adjustable along a length of the strap and/or pivotable on the strap. Preferably, the two or more toilet bowl attachment portions are further comprised of two or more suction cups. Preferably, the strap is substantially U-shaped.

Another embodiment of the invention is a toilet training device, comprising: a target; a strap; two suction cups; two lever hinges; and two levers; wherein the target is attached to a center of the strap; wherein the two suction cups secure the toilet training device a rim of a toilet bowl via the; wherein the two levers are attached to two ends of strap at the two hinges such that the two levers counter balance the strap such that when the toilet seat is down the two levers cause the strap to be positioned along the rim of the toilet bowl and when the toilet seat is up the strap shifts such that the target is positioned substantially in a center of the toilet bowl. Preferably, the target is sports goal. The sports goal target may be a basketball hoop. The basketball hoop target may further be comprised of a backboard. The target may be adjustable along a length of the strap. The target may be pivotable on the strap. The strap is preferably substantially U-shaped.

Another embodiment of the present invention is a target connected to the center of a strap, which is preferably plastic, which extends from and is connected to, the center of the sides of a toilet bowl. The plastic strap is preferably connected to the approximate center of the sides of the toilet bowl by a set of mounting suction cups. The device also includes counter levers to the plastic strap that are designed to engage with the bottom of the toilet seat, such that the target dangles in the very center of the bowl when the seat is up, but the target and the strap swing to the back edge of the toilet bowl when the seat is down. The plastic strap and target swing back to the center of the bowl when the seat is lifted.

It is an object of this device to provide a fun way for boys to learn to direct their urine into the center of a toilet by giving them a target at which to aim. It is an object of this invention to have the target swing into place when the toilet seat is up and to move out of the way when the toilet seat is down.

Another object of this device is to encourage potty training boys to pee while standing up by transforming the mundane act of peeing standing up into a fun and challenging game for boys to play every time they need to pee.

Another object of this device is to provide a potty training device that overcomes the limitations of the prior art.

Other features and advantages that are inherent in the potty training device, claimed, and disclosed will become apparent to those skilled in the art from the following detailed description and its accompanying drawings.

### BRIEF DESCRIPTION OF THE DRAWING

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a perspective view of one embodiment of the toilet training device.

FIG. 2 is an illustration of a perspective view of one embodiment of the toilet training device and shows the toilet training device attached to the rim of a toilet bowl with the toilet lid up.

FIG. 3 is an illustration of a top view of one embodiment of the toilet training device.

FIG. 4 is an illustration of a side view one embodiment of the toilet training device and shows the position of the toilet training device when the toilet seat is down.

### DETAILED DESCRIPTION OF THE DRAWINGS

In the following detailed description of the various embodiments of the invention, numerous specific details are set forth in order to provide a thorough understanding of various embodiments of the invention. However, one or more embodiments of the invention may be practiced without the specific details. In other instances, well known methods, procedures, and/or components have not been described in detail so as not to unnecessarily obscure aspects of embodiments of the invention.

In the following detailed description of the various embodiments of the invention, reference is made to the accompanying drawings that form a part hereof, and in which is shown by way of illustration a specific embodiment in which the invention may be practiced. It is to be understood that other embodiments may be utilized and structural changes may be made without departing from the scope of the present invention. Accordingly, the drawings and detailed description are to be regarded as illustrative in nature and not restrictive. In addition, the reference or non-reference to a particular embodiment of the invention shall not be interpreted to limit the scope of the invention.

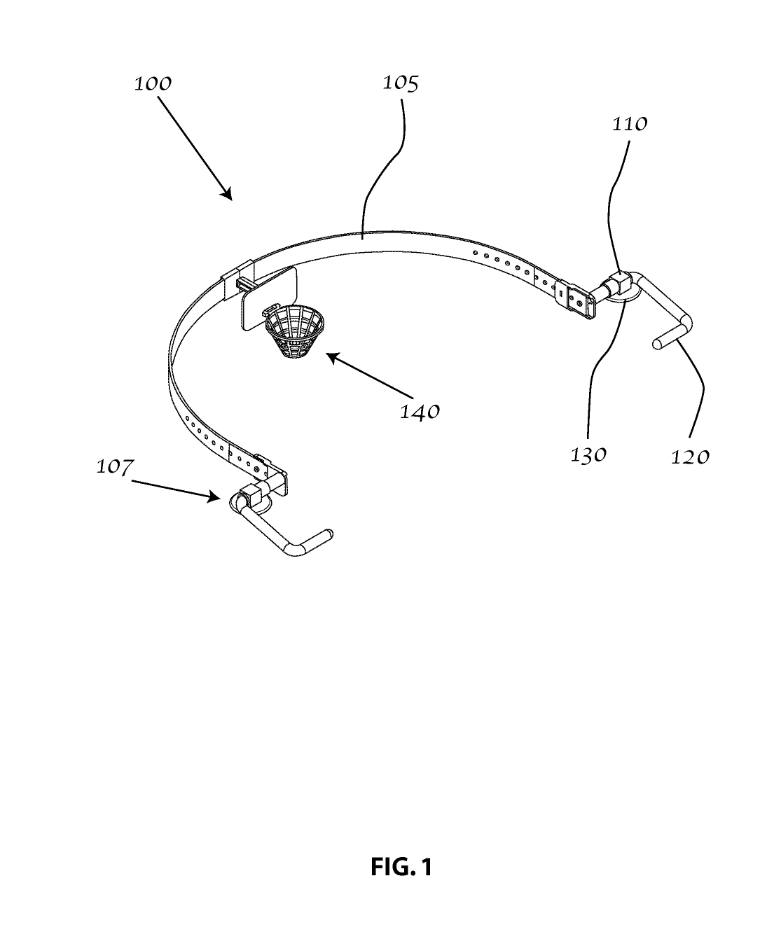

FIG. 1 is an illustration of a perspective view of one embodiment of the toilet training device. As shown in FIG. 1, the toilet training device 100 is preferably comprised of a strap 105, attachment portions 107, levers 120, and target 140. The attachment portions 107 are preferably comprised of suction cups 130 and hinge 110. The strap 105 is preferably a plastic adjustable length strap that is substantially rigid, but flexible on its flat side and substantially inflexible on its edge. The strap 105 may also be a chain, wire, belt, hose, pipe, strip, or band. Importantly, the strap 105 should be configured to hang substantially in the center of a toilet bowl when the toilet seat is raised or up. Additionally, the strap 105 may be configured to move, slide, shift, or swing out of the way (to the side, back, or front along the rim of the bowl) when the toilet seat is lowered or down. FIG. 1 shows how the strap 105 may be U-Shaped.

As shown in FIG. 1, the target 140 is preferably positioned at a center of the strap 105. The target 140 may be adjusted along the length of the strap 105 and is preferably a sports related target, such as a soccer goal, hockey net, or, as shown, a basketball hoop and backboard. But, the target 140 may be any target, including non-sports related targets without deviating from the scope of the invention. Although FIG. 1 only shows one target 140, the device 100 may include more than one target without deviating from the scope of the invention.

FIG. 1 also shows how the levers 120 connect to the strap 105 at hinge 110. In this embodiment, hinge 110 is a fulcrum or fulcrum hinge that counterbalances or counter levers the levers 120 and the strap 105. Although two levers are shown, the device may have one lever or more than two levers without deviating from the scope of the invention.

Preferably, the strap 105 and target 140 are made of plastic, but they may be made from any non-rusting metal, rubber, composite, natural, synthetic, or man-made material. Preferably, the levers 120 are made from metal, but they may be made from a durable and rigid plastic or any other type of material.

FIG. 1 also shows how the device 100 is removeably attached to the rim of a toilet seat using suction cups 130. However, any attachment device may be used, including clamps, adhesives, bolts, screws, or friction. Furthermore, FIG. 1 shows how the hinge 110 is preferably positioned at the attachment portions 107 to provide the best balance.

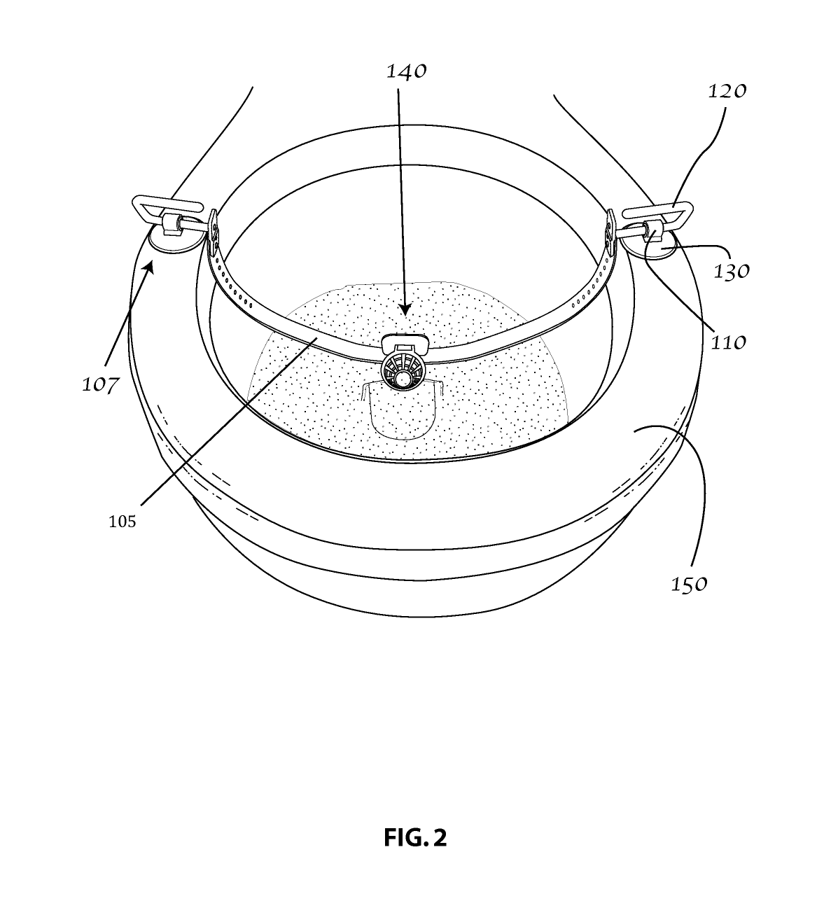

FIG. 2 is an illustration of a perspective view of one embodiment of the toilet training device and shows the toilet training device attached to the rim of a toilet bowl with the toilet lid up. As shown in FIG. 2, the toilet training device 100 is preferably comprised of a strap 105, attachment portions 107, levers 120, and target 140. The attachment portions 107 are preferably comprised of suction cups 130 and hinge 110. FIG. 2 shows how the suction cups 130 removably secure the device 100 to the rim of a toilet bowl 150. FIG. 2 shows how the levers 120 rise upward when the strap 105 and target 140 are in aiming position within the bowl. This allows the levers 120 to be in position to be pushed downward when the toilet seat is put down. The strap is then shifted up to the side of the toilet bowl rim 150 and out of the way.

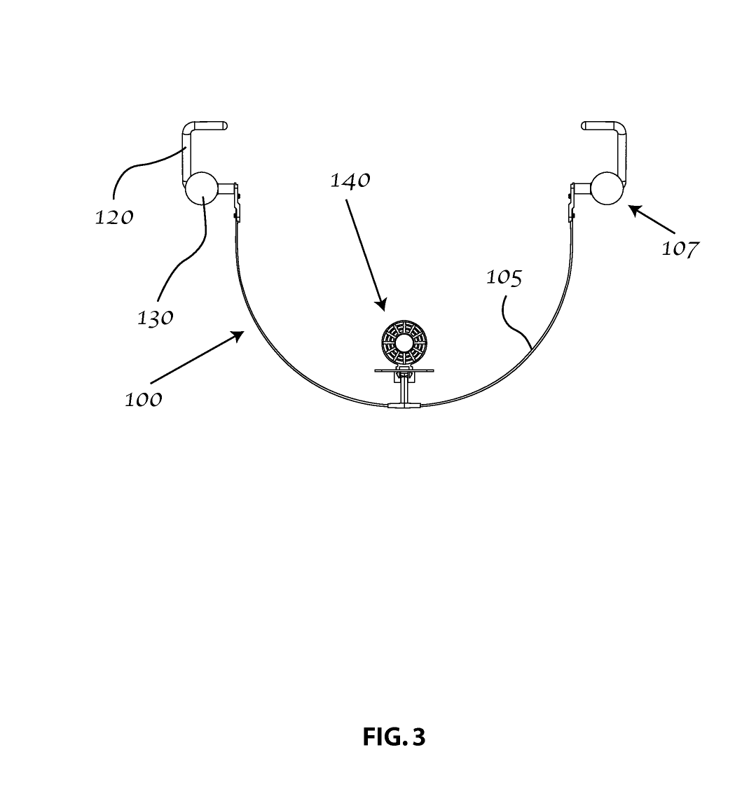

FIG. 3 is an illustration of a top view of one embodiment of the toilet training device. As shown in FIG. 3, the toilet training device 100 is preferably comprised of a strap 105, attachment portions 107, levers 120, and target 140. The attachment portions 107 are preferably comprised of suction cups 130 and hinge 110.

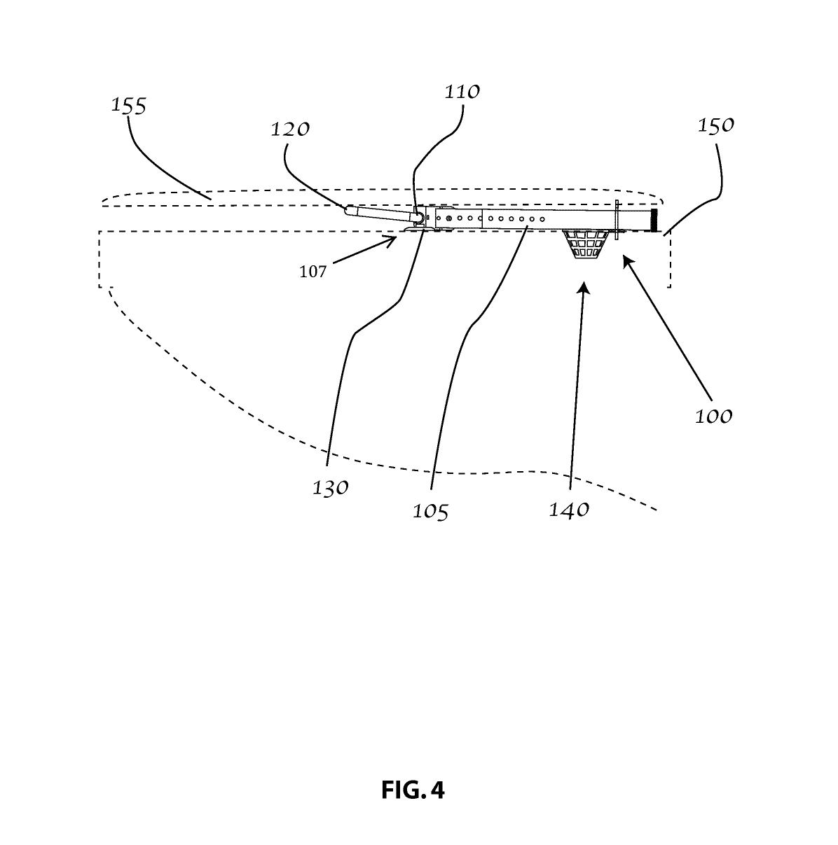

FIG. 4 is an illustration of a side view one embodiment of the toilet training device and shows the position of the toilet training device when the toilet seat is down. As shown in FIG. 4, the toilet training device 100 is preferably comprised of a strap 105, attachment portions 107, levers 120, and target 140. The attachment portions 107 are preferably comprised of suction cups 130 and hinge 110. FIG. 4 shows how the suction cups 130 removably secure the device 100 to the rim of a toilet bowl 150. FIG. 4 shows how when toilet seat 155 is put down, the lever 120 is pushed down and the strap 105 and target 140 counter by hinging at fulcrum hinge 110 and shifting to the edge or side of toilet bowl 150. FIG. 4 also shows how target 140 is pivotable on strap 105.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope of the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

1. A toilet training device, comprising:
one or more targets;
a strap; and
one or more levers;
wherein said one or more targets are attached to said strap;
wherein said one or more targets are movable along a length of said strap;
wherein said length of said strap is adjustable;
wherein said strap is substantially U-shaped;
wherein said toilet training device is attached to a rim of a toilet bowl; and
wherein said one or more levers are attached to said strap such that said one or more levers counter balance said strap such that when a toilet seat is down said one or more levers cause said strap to be positioned along said rim of said toilet bowl and when said toilet seat is up said strap shifts such that said one or more targets are positioned substantially in a center of said toilet bowl.

2. The toilet training device of claim 1, further comprising:
two or more toilet bowl attachment portions;
wherein said two or more toilet bowl attachment portions are attached to said strap and secure said toilet training device to said rim of said toilet bowl.

3. The toilet training device of claim 2,
wherein each of said two or more toilet bowl attachment portions are comprised of a lever hinge;
wherein said lever hinge allows said strap to shift from being positioned along said rim of said toilet bowl to being positioned substantially in center of said toilet bowl.

4. The toilet training device of claim 3, wherein said one or more targets are one or more sports goals.

5. The toilet training device of claim 4, wherein said one or more sports goal targets are one or more basketball hoops.

6. The toilet training device of claim 5, wherein said one or more basketball hoop targets are further comprised of one or more backboards.

7. (canceled)

8. The toilet training device of claim 3, wherein said one or more targets are pivotable on said strap.

9. The toilet training device of claim 3, wherein said two or more toilet bowl attachment portions are further comprised of two or more suction cups.

10. (canceled)

11. A toilet training device, comprising:
one or more targets;
a strap;
one or more levers; and
two or more toilet bowl attachment portions;
wherein said one or more targets are attached to said strap;
wherein said length of said strap is adjustable;
wherein said strap is substantially U-shaped;
wherein said toilet training device is attached to a rim of a toilet bowl;
wherein said one or more levers are attached to said strap such that said one or more levers counter balance said strap such that when a toilet seat is down said one or more levers cause said strap to be positioned along said rim of said toilet bowl and when said toilet seat is up said strap shifts such that said one or more targets are positioned substantially in a center of said toilet bowl;
wherein said two or more toilet bowl attachment portions are attached to said strap and secure said toilet training device to said rim of said toilet bowl;
wherein each of said two or more toilet bowl attachment portions are comprised of a lever hinge and one or more suction cups;
wherein said lever hinge allows said strap to shift from being positioned along said rim of said toilet bowl to being positioned substantially in said center of said toilet bowl;
wherein said one or more targets are one or more basketball hoops with backboards;
wherein said one or more targets are adjustable along a length of said strap; and
wherein said one or more targets are pivotable on said strap.

12. A toilet training device, comprising:
a target;
a strap;
two suction cups;
two lever hinges; and
two levers;
wherein said target is attached to a center of said strap;
wherein said one or more targets are movable along a length of said strap;
wherein said length of said strap is adjustable;
wherein said strap is substantially U-shaped;
wherein said two suction cups secure said toilet training device onto a rim of a toilet bowl; and
wherein said two levers are attached to two ends of said strap at said two hinges such that said two levers counter balance said strap such that when a toilet seat is down said two levers cause said strap to be positioned along said rim of said toilet bowl and when said toilet seat is up said strap shifts such that said target is positioned substantially in said center of said toilet bowl.

13. The toilet training device of claim 12,
wherein said target is a sports goal.

14. The toilet training device of claim 13,
wherein said sports goal target is a basketball hoop.

15. The toilet training device of claim 14,
wherein said basketball hoop target is further comprised of a backboard.

16. (canceled)

17. The toilet training device of claim 12,
wherein said target is pivotable on said strap.

18. (canceled)
